(19) United States
(12) Patent Application Publication
(10) Pub. No.: US 2021/0118071 A1
(43) Pub. Date: Apr. 22, 2021

(54) Artificial Intelligence Based Recommendations

(71) Applicant: Oracle International Corporation, Redwood Shores, CA (US)

(72) Inventors: Dhruv AGARWAL, Delhi (IN); Akash CHATTERJEE, Gurgaon (IN); Anirban BANERJEE, Kolkata (IN)

(21) Appl. No.: 16/719,040

(22) Filed: Dec. 18, 2019

(30) Foreign Application Priority Data
Oct. 22, 2019 (IN) 201941042843

(51) Int. Cl. G06Q 50/12; G06N 5/04; G06Q 30/06; G06Q 30/02

(52) U.S. Cl. CPC G06Q 50/12; G06Q 30/0204; G06Q 30/0631; G06N 5/04

(57) ABSTRACT

Embodiments provide recommendations to a guest of a hotel or other type of service industry. Embodiments receive input data including demographics data and preference data for a plurality of guests of the hotel, and receive a plurality of guest interest categories. Embodiments assign one or more keywords to each of the guest interest categories and extract a plurality of attributes from the input data concerning the guest. Embodiments perform semantic analysis to map the attributes to the guest interest categories and determine a plurality of guest similarity calculations comprising a similarity value each of the plurality of guests with every other plurality of guests. Embodiments then generate a plurality of guest interest categories predictions for each of the guests based on the determined guest similarity calculations.

### FIELD

One embodiment is directed generally to an artificial intelligence system, and in particular to an artificial intelligence system that provides recommendations.

### BACKGROUND INFORMATION

In connection with the hotel industry, as well as other service industries, there generally is a direct correlation between personalization and a positive hotel stay experience, which in turn translates to higher revenue on-property, good reviews on social media, and higher guest turnover. However, there exists a core problem of being able to actualize these benefits by implementing personalization at scale. In general, there is no efficient way for hoteliers to either get a deep understanding of these interests or to map them to revenue generating up-sell and cross-sell offers. Further, it is extremely difficult to personalize experiences for first time guests which, in the absence of artificial intelligence, leads to a huge opportunity cost incurred resulting in loss of guest loyalty, sub-par reviews, and unrealized revenue potential.

Traditional approaches to profile insight estimation rely on manual data collection in the form of surveys, questionnaires, and hotel staff intuition. These surveys are often static and fail to provide actionable insights in many cases, serving only to give generic statistics. Additionally, most guests might not answer some or even all of the questions on such forms. This heavy reliance on manual efforts to collect and interpret data increases exponentially with the scale of the hotel's guest turnover, making it infeasible for large chains to maintain a consistent guest experience across different properties.

### SUMMARY

Embodiments provide recommendations to a guest of a hotel or other type of service industry. Embodiments receive input data including demographics data and preference data for a plurality of guests of the hotel, and receive a plurality of guest interest categories. Embodiments assign one or more keywords to each of the guest interest categories and extract a plurality of attributes from the input data concerning the guest. Embodiments perform semantic analysis to map the attributes to the guest interest categories and determine a plurality of guest similarity calculations comprising a similarity value each of the plurality of guests with every other plurality of guests. Embodiments then generate a plurality of guest interest categories predictions for each of the guests based on the determined guest similarity calculations.

### BRIEF DESCRIPTION OF THE DRAWINGS

FIG. 1 is a block diagram of a computer server/system in accordance with an embodiment of the present invention.

FIG. 2 is a flow diagram that illustrates the functionality of an AI based recommendations module of FIG. 1 in accordance to embodiments.

FIG. 3 is a graph of an example similarity calculation in accordance to embodiments of the invention.

FIG. 4 graphically illustrates the functionality of embodiments of the invention.

FIG. 5A illustrates a mapping of suggestions to interests in accordance with embodiments.

FIG. 5B illustrates the product determination in accordance with embodiments.

FIG. 6 illustrates a Guest/Interest matrix, a Suggestion/Interest matrix and a Guest/Suggestion matrix in accordance to embodiments.

FIGS. 7A and 7B illustrate the feedback algorithm for positive cases and negative cases, respectively, in accordance to embodiments.

FIG. 8A illustrates experimental results for preference prediction calculations in accordance to embodiments of the invention.

FIGS. 8B and 8C illustrate the prediction values for a single guest in accordance to embodiments.

FIG. 9 illustrates example predicted business opportunities generated by embodiments of the invention.

FIG. 10 illustrates an example user interface in accordance to embodiments.

### DETAILED DESCRIPTION

Embodiments provide recommendations for guests of hotels or other services in order to personalize their on-premise stay experience, allowing hoteliers to increase guest loyalty, improve brand value, and capitalize on guest spend potential. Embodiments implement a hybrid Collaborative-Filtering (“CF”) machine learning to generate behavior profiles and actionable insights based on booking profiles, stated preferences, travel purposes, and transaction history extracted from a property management system database. Embodiments implement a recommendation engine that find trends in guest similarity while also incorporating techniques to make it robust against incomplete information as well as concept drift (i.e., the changing relationship between the input data and guest behavior due to change in guest interests over time).

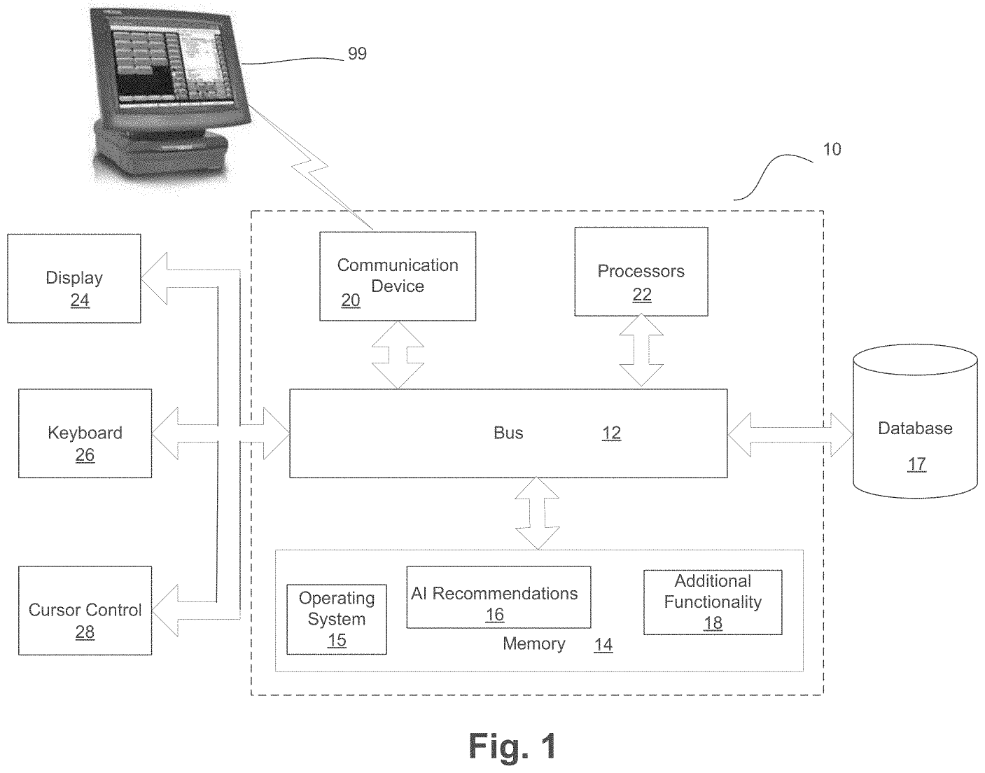

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an artificial intelligence (“AI”) recommendations module 16 that provides hotel based recommendations, and all other functionality disclosed herein. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 99 generates transactional data and historical sales data (e.g., data concerning transactions of hotel guests/customers) used for generating the recommendations. POS terminal 99 itself can include additional processing functionality to perform AI based recommendations in accordance with one embodiment and can operate as a specialized AI based recommendations system either by itself or in conjunction with other components of FIG. 1.

In one embodiment, particularly when there are a large number of hotel locations, a large number of guests, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

As described, known profile insight estimation in the hotel and other service industries is generally done manually through surveys, questionnaires, and hotel staff intuition. For most guests, personalization starts with getting the room features and special requests that guests asked for during booking. However, there are also a significant number of guests for whom no preference data is captured. Currently, personalization for these guests generally goes unaddressed.

In contrast, embodiments implement a novel hybrid Collaborative Filtering algorithm that determines the interests of guests and generate insights and suggestions pertinent to them. These recommendations allow hotels to capitalize on cross-sell/upsell opportunities, and maximize guest spend potential. Personalized guest experiences help increase guest loyalty and turnover, and in turn, increase overall hotel revenue.

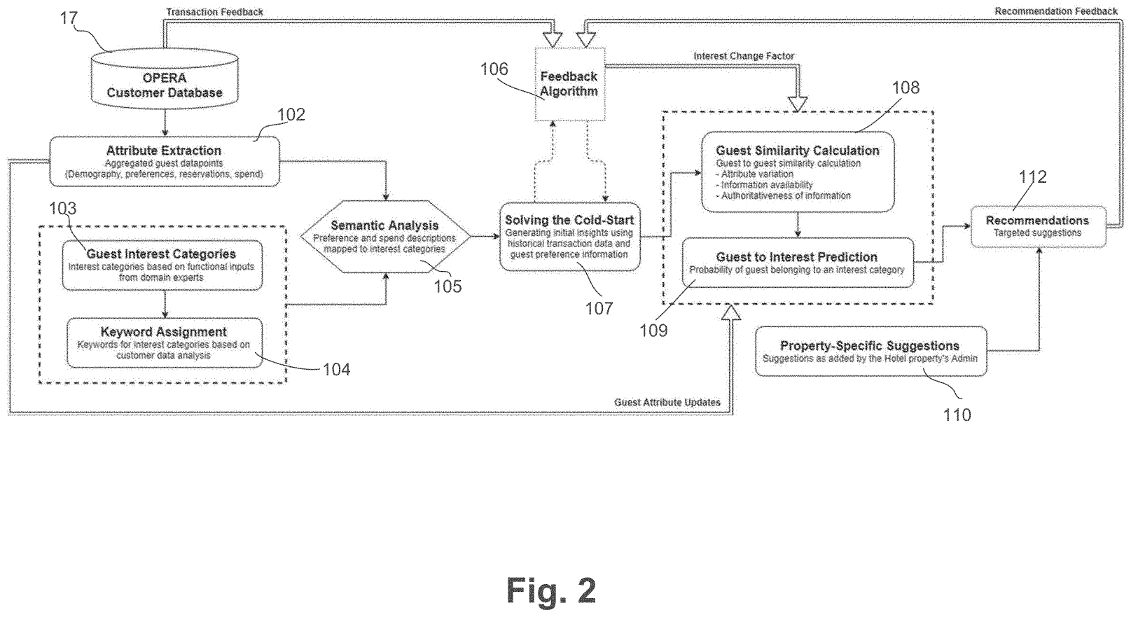

FIG. 2 is a flow diagram that illustrates the functionality of AI based recommendations module 16 of FIG. 1 in accordance to embodiments. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Embodiments use an input dataset/database 17 to generate recommendations. In one embodiment, input dataset 17 is an “OPERA” database from Oracle Corp. and includes details on guests of a single hotel or a group of related hotels such as a chain of hotels. In other embodiments, a database of data regarding guests for any type of PMS can be used. The data for each guest itself includes two parts in embodiments:

1. “PMS” data: Data regarding a guest's demographic (e.g., nationality and importance) and also a guest's past reservation details (e.g., total stays, average occupants, room types, and revenue details).

2. “Preference” data: Data regarding a guest's inclinations towards a pre-defined set of preference categories such as “Food”, “Relaxation”, and “Shopping” with values ranging from −1 (indicating dislike) and +1 (indicating strong affinity). In embodiments, the preference data is automatically generated using existing transaction data and optionally any stated unstructured preference data that may be captured manually. The preference data is for all of the guests in database 17 in embodiments.

Embodiments perform pre-processing of the data from database 17. After importing the raw data files, the data needs to be prepared appropriately before any analysis can be done using it. The following processes are performed as pre-processing steps in embodiments (and are generally implemented at 102 in FIG. 2 below):
1. Replacing all null/NaN values with appropriate imputation values depending on the datatype of the column in consideration.
2. Purging columns with high correlation to reduce dataset dimensionality in order to improve and speed up data analysis.
3. Encoding categorical-value columns to numerical values, followed by one-hot encoding.
4. Detecting outliers and keeping them aside before proceeding to the next step.
5. Scaling all the features to values between −1 and 1 in order to optimize later calculations.
6. Applying Principal Component Analysis (“PCA”) in order to further reduce dimensionality.

At 102, embodiments extract attributes from database 17, which include aggregated guest datapoints (e.g., demography, preferences, reservations, spend). The extracted attributes include structured data from the database, which includes the demographic and reservation attributes for all guests in database 17. In one embodiment, examples of the demographic and reservation attributes include the following: VIP_STATUS, GENDER, AGE, CITY, COUNTRY, TOTAL_STAYS, AVG_NIGHTS (i.e., average number of nights a particular guests usually stays at the hotel), AVG_ADULTS, AVG_CHILDREN, AVG_ROOMS (i.e., average number of rooms the guests usually books when he/she visits the hotel), MAX_ROOMS (i.e., the maximum number of rooms in a single reservation that a particular guest has booked at the hotel), MAX_ROOM_TYPE (i.e., the room type that the guest has booked the most number of times in his/her reservation history), BEST_ROOM_TYPE (i.e., the costliest room type that the guest has booked in his/her booking history), AVG_ROOM_REVENUE, AVG_FB_REVENUE (i.e., the average revenue spent by the guests for food and beverages), AVG_TOTAL_REVENUE.

The extracted attributes at 102 further include unstructured guest preference data, which are preferences that are specified by the guests at the time of booking or during their stay. Examples of such attributes include: “Non-smoking room”, “City tour package”, “Banquet Space Features”, “Bed (160) Length 210 cm”, “Dog Facilities”, “12th Floor”, “2 TV Sets”.

The extracted attributes at 102 further include transaction information, which are codes and descriptions that are used to manage all on-premise transactions. Examples include: HFS—“High Flyers Show Admission”, IRM—“In Room Movies”, DFB —“Diners”, BCT—“Business Center Tax”, PH1—“Local Phone Calls”, PH4—“Long Distance Phone Calls”, LAU—“Laundry”, BDR—“Roll-a-Way Bed Charge”.

As an additional input, at 103 guest interest categories are received, which are interest categories based on functional inputs from domain experts (i.e., hotel experts). In one embodiment, the following guest interest categories are used, but in other embodiments, any number of different categories can be pre-defined and used:
ADVENTURE: Encompasses activities that provide an exciting experience typically involving, but not exclusive to, physically taxing or thrill-seeking endeavors. Examples: Skydiving, Hiking, Scuba Diving, etc.
ENTERTAINMENT: Affinity to experiences in spheres such as music, dance and theatre.
FOOD AND BEVERAGES: Love for food and drinks as well as a higher spend footprint of the same inside the hotel
LEISURE: Attracted to available opportunities that provide relaxation, primarily on wellness offerings, inside hotel premises. Examples: Spa, Aromatherapy, etc.
SIGHTSEEING: Interest in exploring the local culture and interesting places nearby. Examples: Museums, Castles, etc.
SPORTS AND FITNESS: Fond of playing or watching sports and/or regularly partake in fitness-related activities.

At 104, embodiments assign keywords to each of the interest categories of 103 based on customer data analysis. In one embodiment, the following keywords are assigned to each of the guest interest categories of 103 (in other embodiments, any number or variety of keywords can be used and assigned):
ADVENTURE: adventure, camping, climbing, hiking, rafting, scuba, spelunking, trekking.
ENTERTAINMENT: carnival, casino, cinema, concert, dance, entertainment, festival, film, movie, music, musical, nightlife, opera, party, play, show, theatre.
FOOD AND BEVERAGES: alcohol, bar, barbecue, beer, beverage, breakfast, brunch, buffet, champagne, cuisine, diner, dinner, food, gourmet, juice, lunch, rum, whiskey, wine.
LEISURE: aromatherapy, leisure, massage, relax, sauna, spa, therapy, wellness.
SIGHTSEEING: cruise, garden, local, museum, picnic, shopping, sightseeing, tour, trip.
SPORTS AND FITNESS: cricket, exercise, fitness, football, golf, gym, hockey, rugby, sport, swim, swimming, tennis, yoga.

At 105, embodiments perform semantic analysis to map the preference and spend descriptions from attribute extraction 102 to guest interest categories 103. In embodiments, the semantic analysis identifies words by checking how similar they are to the meanings of the keywords rather than doing a one to one word matching with the keywords. At 105, embodiments leverage the unstructured guest preferences and transaction descriptions that are relevant and attempt to map them to interest categories using the python library “spaCy” word vectors. The semantic analysis algorithm assigns a probability value between 0 and 1 for each description in each of the Interest categories.

For example, if the guest preference data/description is “Trekking”, the following probability values may be assigned to each interest category: Adventure: 0.8, Entertainment: 0, Food and Beverages: 0, Leisure: 0, Sightseeing: 0, Sports and Fitness: 0.5. In this example, the highest probability value is for the “Adventure” category.

In another example, if a transaction description is: “Aromatherapy package”, the following probability values may be assigned to each interest category: Adventure: 0, Entertainment: 0, Food and Beverages: 0, Leisure: 0.9, Sightseeing: 0, Sports and Fitness: 0. In this example, the highest probability value is for the “Leisure” category.

At 107, embodiments solve for a “cold-start” by generating initial insights using historical transaction data and guest preference information. Solving the cold-start problem in general includes the following:
The transaction history of all the guests in database 17 are categorized according to the preference categories. This is used to increase the values of the Preference Data for each guest based on their individual spends in those categories.
In addition, the negative values for Preference Details are simulated for those guests which had missing values for preference categories which are popular. For example, if guest A has a null value in the Food category, and the Food category otherwise has data for 90% of the guests in database 17, embodiments then proceed with the assumption that missing data implies a dislike of that category for guest A.

The cold-start reduces the initial data sparsity and results in more accurate guest-to-guest similarity calculations. After semantic analysis 105, embodiments at 107 generate guest insights from historical data resulting in values ε [−1, 1] using the following:

1. Guests with Preferences: Guests, who had provided preferences, are assigned the values in the interest categories based on the semantic analysis results of their descriptions.

2. Transaction Feedback Simulation: Transaction history is used to map guests to the interest categories by simulating a positive feedback loop for each transaction log.

3. Negative Interest Simulation: Negative values are assigned to guests for Interest categories where there is no information from the database for them, but are otherwise popular Interests for most other guests.

As an example of transaction feedback simulation, assume a guest has transacted 5 times using the Aromatherapy package. In response, positive feedback is simulated 5 times for the guest for the “LEISURE” category. This increases the value for the guest in LEISURE, pushing it closer to 1 from an initial 0.

In experimental testing, using details of 20,114 guests in database 17, Before Cold-Start 107 (i.e., Transaction Feedback Simulation), guests with authoritative (>=0.5) information (in at least one Interest category)=332. After performing the Transaction Feedback Simulation portion of the cold-start, guests with authoritative information (in at least one Interest category)=19,825 (i.e., an approximately 60× increase). These statistics are relevant to the transaction feedback simulation aspect of the cold-start, and not relevant or calculated for the other aspects.

At 108, embodiments calculate a guest similarity, which results in the calculation of a similarity value from 0 to 1 of each guest in database 17 with every other guest in database 17 using a novel pair-wise Euclidean similarity calculation. Then, at 109, embodiments generate a prediction of each guest to one of the interest categories 103, including a probability of each guest belonging to each category. The pair-wise Euclidean similarity calculation is based on: (1) a comparison of variations in attributes for each pair of guests; (2) the availability of information for a guest; and (3) the evaluation of the authoritativeness of the available data.

In general, the functionality of 108 and 109 utilizes artificial intelligence (“AI”) or machine learning technique of Collaborative Filtering (“CF”). CF can be used by recommender systems to make automatic predictions (i.e., filtering) about the interests of a user by collecting preferences or taste information from many users (i.e., collaborating). CF is based on the idea that people who agreed in their evaluation of certain items in the past are likely to agree again in the future.

For example, assume person A and person B both like movies X, Y, and Z. While person A and person C both only have movie W in common. Then, while recommending a movie to person A, the algorithm will rely more heavily on reviews by person B rather than those by person C, since person A and person B are more similar.

A CF system can be broken down into 2 steps: (1) Estimate pair-wise similarities between all users. This can be done using just user ratings, just user demographics, or a combination of both; (2) Use the similarity scores to calculate a weighted average of an unrated item for the active user (i.e., the user being currently evaluated).

Embodiments use a novel Euclidean-distance based function which takes a weighted average of the similarity of PMS data from database 17 together with the similarity of Preference data from database 17 as follows (all equations below represent vectorized operations):

Similarity Modelling

PMS Data Similarity:
Let EDₚₘₛ be the Euclidean distances between every pair of guests using only the PMS data features;
Scale EDₚₘₛ to values between 0 and 1 using x_{scaled}=min_{new}+max_{new}*(x_{orig}−min_{old})/(max_{old}−min_{old})

=>ED_{pms,scaled}=EDₚₘₛ/(2*(num_featuresₚₘₛ)^{0.5})

=>PMS Data Similarity=EDSimₚₘₛ=1−ED_{pms,scaled}

Preference Data Similarity:
This data require special handling due to the sparsity of the set and the latent semantics of the possible values (˜0 indicates an unauthoritative or unknown value, ˜±1 indicates an authoritative value).
Embodiments include 2 multiplicative factors, which combined with the Preference Data Euclidean Similarity, yields the estimate of similarity for the preference data.
Let ED_{prefs} be the Euclidean distances between every pair of guests using only the Preference Data features;
Scale ED_{prefs} to values between 0 and 1 using x_{scaled}=min_{new}+max_{new}*(x_{orig}−min_{old})/(max_{old}−min_{old})

=>ED_{prefs,scaled}=ED_{prefs}/(2*(num_features_{prefs})^{0.5})

=>Preference Data Euclidean Similarity=EDSim_{prefs,raw}=1−ED_{prefs,scaled}

### Defining the Multiplicative Factors

Let sim_pref_factor1 be the first multiplicative factor which augments similarity contribution from pairs where information content of values is high (authoritative), and attenuates contribution where values are ˜0 (unauthoritative) (all the below calculations are done pairwise for each guest-guest combination in the dataset):

Let info_content_{pairwise} be the total sum of the absolute values contained in all the preference data columns for any guest pair in consideration;
Let nₚ be the number of pre-defined categories of preferences in the database; prefᵢ be the cumulative value of the i^{th} preference for a pair of guests

=>info_content_{pairwise=(pairwise)}Σ^{i=[1,n}^{ₚ}^{]}|prefᵢ|;

Let pref_contrib_{pairwise} be the fraction of the total number of preferences nₚ, which have any authoritative information for the pair of guests in consideration

=>pref_contrib_{pairwise=(pairwise)}Σ^{i=[1,n}^{ₚ}^{]}f(|prefᵢ|), where f(x)=(1+tan h(5×−4))/2

=>sim_pref_factor₁=info_content_{pairwise}/(2*pref_contrib_{pairwise});

Let sim_pref_factor₂ be the second multiplicative factor which augments similarity contribution from pairs where the number of authoritative preference pairs are higher (all the below calculations are done pairwise for each guest-guest combination in the dataset):

=>sim_pref_factor₂=g(pref_contrib_{pairwise}), where g(x)=tan h(x/2)

### Combining the Preference Similarity with the Factors

=>Preference Data Similarity=EDSim_{prefs}=EDSim_{prefs,raw}*sim_pref_factor₁*sim_pref_factor₂

Combining the Above:
Embodiments take a weighted average of the above 2 similarity calculations with configurable weights to arrive at the final similarity score.

=>Cumulative Guest Similarity=guest_sim=(wₚₘₛ*EDSimₚₘₛ+w_{prefs}*EDSim_{prefs})/(wₚₘₛ+w_{prefs}),
where wₚₘₛ and w_{prefs} are the contributions of the PMS and Preference data to the final similarity calculation.

In general, for the similarly modeling, embodiments convert the following three factors into mathematical formulations: (1) comparison of variations in attributes for each pair of guests; (2) availability of information for a guest; and (3) evaluation of the authoritativeness of the available data. This specifically pertains to the “Defining the Multiplicative Factors” section.

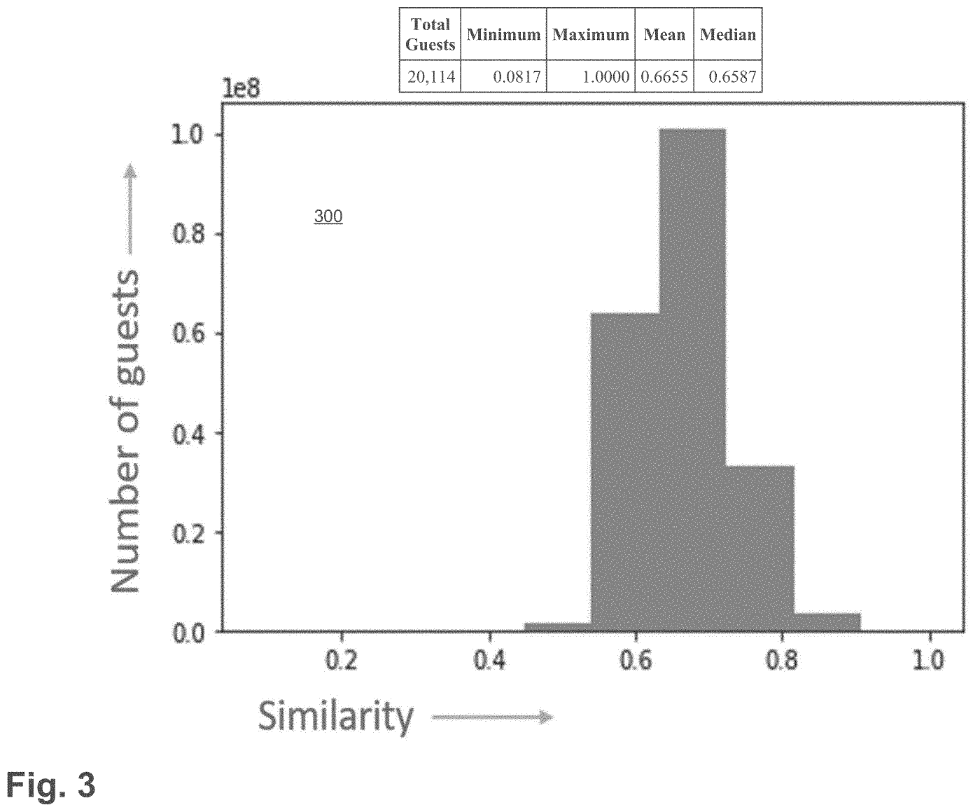

FIG. 3 is a graph 300 of an example similarity calculation in accordance to embodiments of the invention. Graph 300 represents the spread of pairwise similarity values that resulted after performing the functionality of 108 of FIG. 2. The example used to generate graph 300 is based on the following generated statistics:
Total guests: 20,114
Total pair-wise guests: 202,286,498
Minimum: 0.0817
Maximum: 1.0000
Mean: 0.6655
Median: 0.6587

From the above statistics, it is apparent that some pairs of guests had number much lower than the mean (i.e., these guests influenced each other's predictions of interest values much less than the average). Further, some pairs of guests had number much higher than the mean (i.e., these guests influenced each other's predictions of interest values much more than the average).

At 109, embodiments determine a guest to interest prediction for all guests in database 17, which results in the probability of a particular guest belonging to one or more of the interest categories (e.g., Adventure, Entertainment, Food and Beverage, etc.). Embodiments predict the guests' inclination towards each interest using the similarity values and existing interest information. Interest Prediction at 109 is cognizant of the following factors: (1) Guests who are more similar should contribute more towards the prediction; and (2) Guests with low information content for a particular Interest should be given lower importance in the calculation.

Prediction Calculation

The prediction determination at 109 uses the above similarity calculations (from 108) and the existing dataset of preferences for each guest in database 17, and applies matrix multiplication to arrive at the estimated value of the Preferences for each guest based on every other guest in the DB as follows:

Let sim_preds be the similarity predictions
Let guest_prefs be the matrix of guests and their values for the pre-defined categories of preferences, having dimensions [n_{g}*nₚ],
where n_{g} is the number of guests in the database (20,114 in our case)

=>Similarity Predictions=sim_preds=((guest_sim*auth_factorₛᵢₘ)*(guest_prefs*auth_factor_{prefs}))/(auth_factorₛᵢₘ*auth_factor_{prefs})

where

auth_factorₛᵢₘ=(1+tan h(30*guest_sim−24))/2,

auth_factor_{prefs}=(1+tan h(10*|guest_prefs/−4))/2,

represent the contribution of the similarities and the preference values, respectively, to the prediction depending on how authoritative their content is.

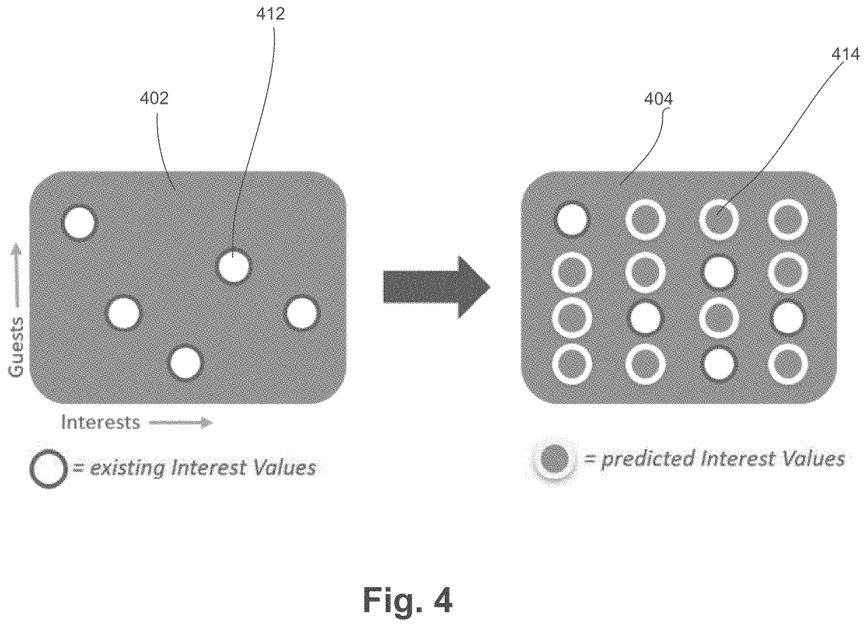

FIG. 4 graphically illustrates the functionality of embodiments of the invention. 402 illustrates existing interest values 412 (i.e., before prediction 109), while 404 illustrates predicted interest values 414. Both 402 and 404 represent a table of guests, where each row is an individual guest, and each column represents an Interest Category. 402 represents the state of the table before the predictions are applied (i.e., after performing the Cold-Start functionality). As shown, at this stage embodiments only have information about a limited number of interests for a limited number of guests. 404 represents the state of the table after the predictions have been calculated. All cells contain a value ranging between −1 and +1, inclusive. As shown, embodiments now have information about each interest for every guest.

As an example of terminology used at 108 and 109, Authoritative Interest Values: |Interest values|>=0.5. For example, the “Food and Beverage” category for a guest=0.7=70% interest in buffet restaurant offers while the “Adventure” category for the same guest=−0.8=80% dislike for Trekking packages. Further, a confident predictions is determined as follows:

Confident Predictions:

|Prediction values|>=0.5

For example: a prediction of “Food and Beverage” category=0.2 represents a weak prediction of a guest's inclination towards food and beverage related recommendations.

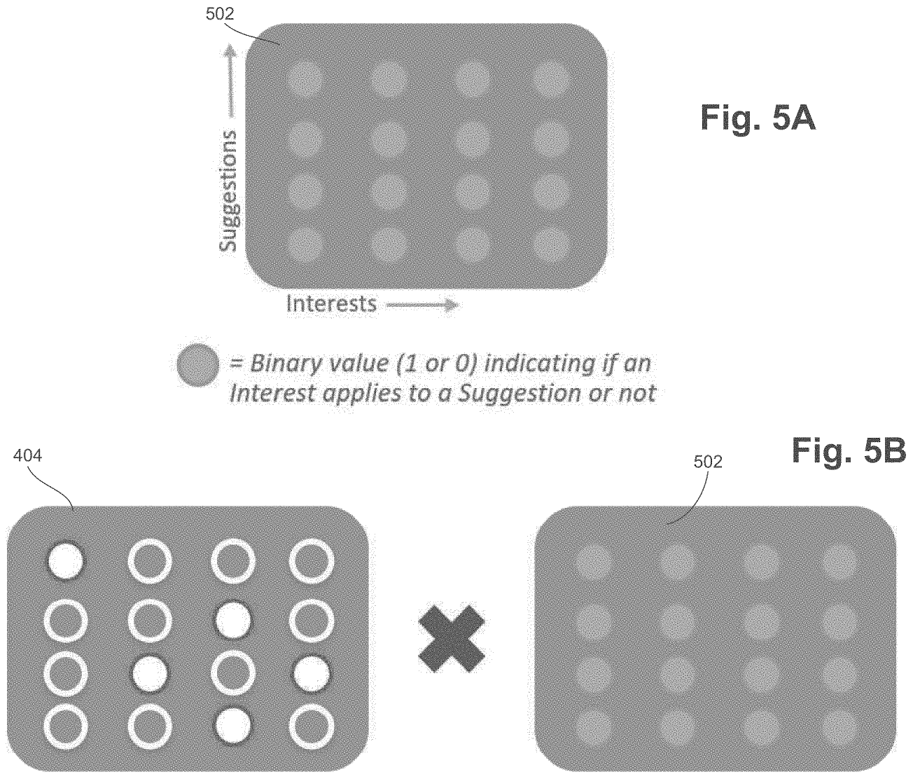

As an additional input, at 110 the hotel can add a list of suggestions to present to guests based on the prediction 109 (or the suggestions can be generically defined), the suggestions forming recommendations (i.e., targeted suggestions) at 112. At 110, these suggestions are mapped to the same pre-defined interest categories, either manually or through an AI-assisted flow. In one embodiment, for the AI-assisted flow, mechanisms similar to used with semantic analysis 105 (i.e., the SpaCy library) is used in order to map the hotel's suggestions to the same Interest Categories using the descriptions of the suggestions. For example, for a package named “Dirt bike trail experience”, the semantic analysis may map to an “Adventure” Interest category. FIG. 5A illustrates a mapping of suggestions to interests in accordance with embodiments.

At 112, the recommendation generation is determined by taking an inner product between the Guest/Interest matrix 404 of FIG. 4, with a Suggestion/Interest matrix 502 of FIG. 5A to arrive at a Guest/Suggestion matrix 602. FIG. 5B illustrates the product determination in accordance with embodiments. Each value lies between 0 and 1, indicating the likelihood of guest uptake for each guest-suggestion pair.

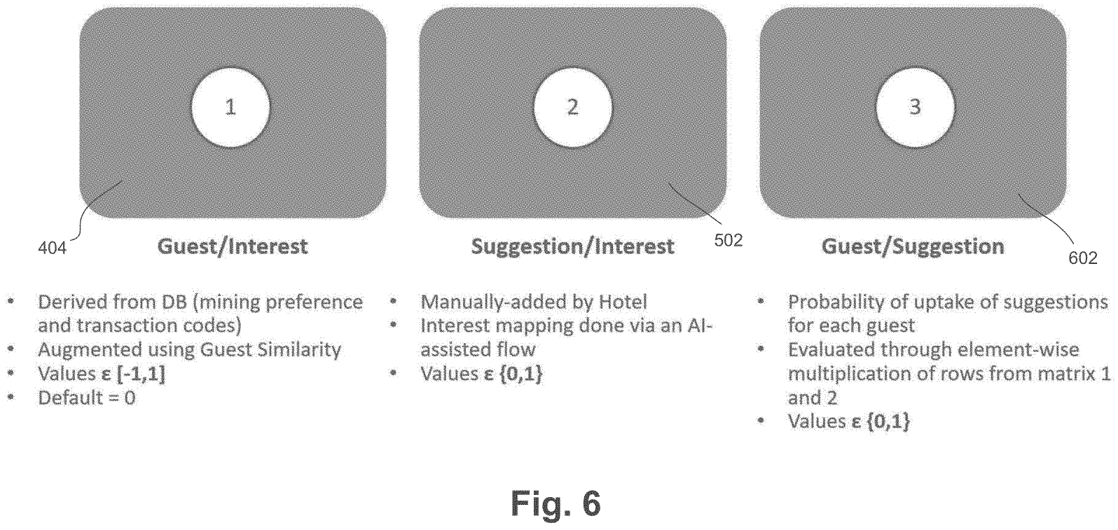

FIG. 6 further illustrates Guest/Interest matrix 404, Suggestion/Interest matrix 502 and Guest/Suggestion matrix 602 in accordance to embodiments.

At 106, embodiments implement a feedback algorithm that receives transaction feedback from database 17 and recommendation feedback from recommendations 112. Feedback 106, when a case is positive, increase those interest values for a guest which map to the invoking recommendation/transaction. A positive feedback could be gauged using the following functionality in embodiments: (1) A UI-driven mechanism explicitly asks the guest or the front-desk agent to punch in a “like” or “dislike” for a recommendation; or (2) Each time a transactions related to the recommendation is taken up by a guest, the system incorporates it as a positive feedback. Additionally, only a critical mass of transaction uptakes will make changes to the guest's interests. Isolated incidents of transaction uptake will not be given much importance in embodiments.

For positive feedback, embodiments attenuate the increment-value on approaching extremes as follows:

x_{guest,inter}+=F(x_{guest,inter})
where F(x)=T(1−x²)

Feedback 106, when a case is negative (determined in embodiments using the same functionality as for positive above), decreases those interest values for a guest which map to the invoking recommendation/transaction. Embodiments attenuate the decrement-value on approaching extremes as follows:

x_{guest,inter}−=F(x_{guest,inter})
where F(x)=T(1−x²)

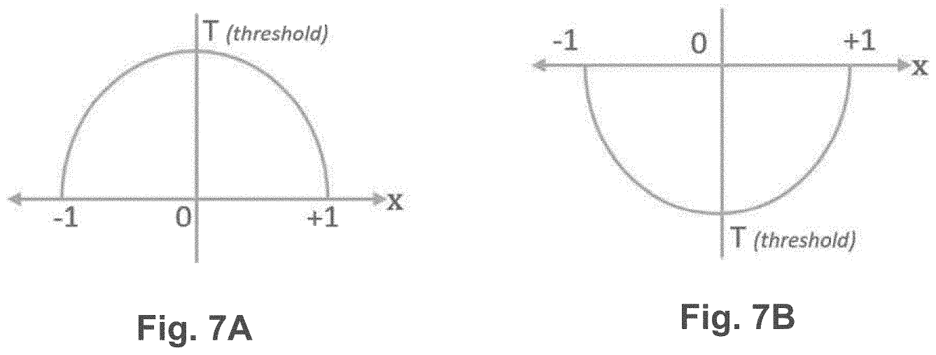

FIGS. 7A and 7B illustrate the feedback algorithm for positive cases and negative cases, respectively, in accordance to embodiments. Embodiments retrain the CF model using the updated values after a critical mass of feedback has been collected through user interaction.

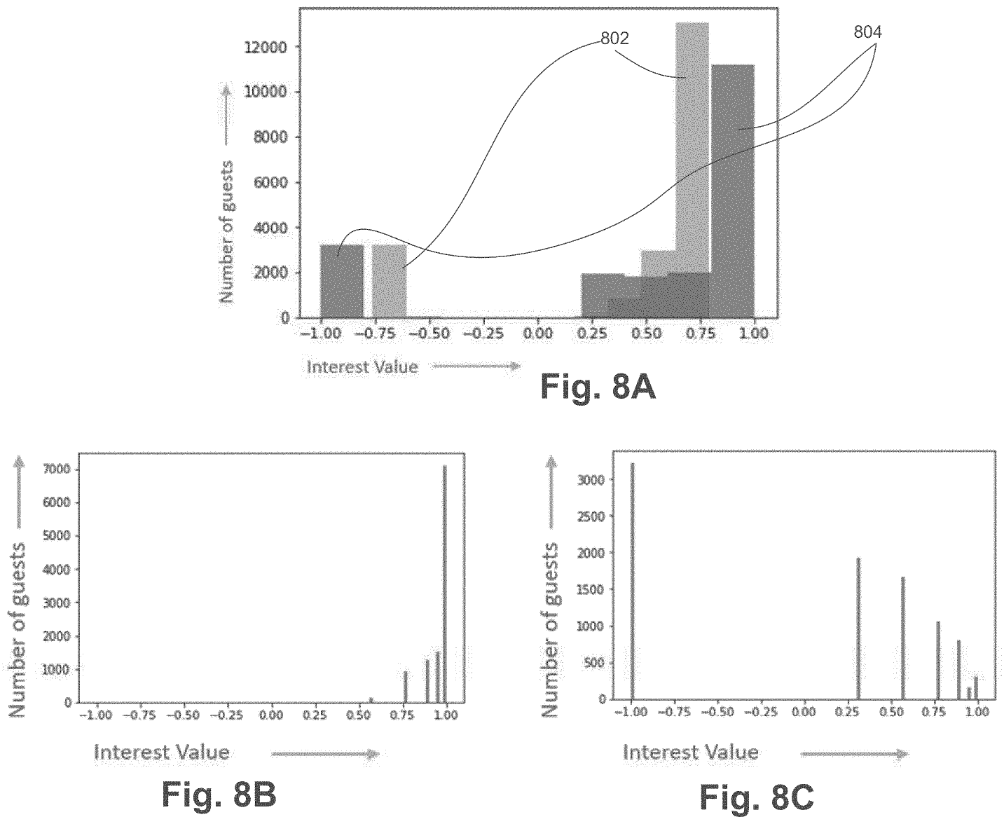

FIG. 8A illustrates experimental results for preference prediction calculations in accordance to embodiments of the invention. FIG. 8A is for the “Food and Beverage” category, but experimental results were performed for 16 different categories. The experimental results were run on data for 20,114 guests, and result in a classification accuracy of 99.2%, which represents the accuracy of the authoritative (>=0.5) Interest values against confident (>=0.5) predictions, and a classification confidence of approximately 72%. The original interest values are shown at 804 and the predicted interest values are shown at 802.

FIGS. 8B and 8C illustrate the prediction values for a single guest in accordance to embodiments. The original value is 1.0, and the predicted value is 0.79. In embodiments, the exact value is less important than the ability to predict a positive or negative inclination towards a particular interest. FIG. 8B illustrates the interest distribution of similar guests (>=70% similarity) and FIG. 8C illustrates the interest distribution of dissimilar guests (<70% similarity).

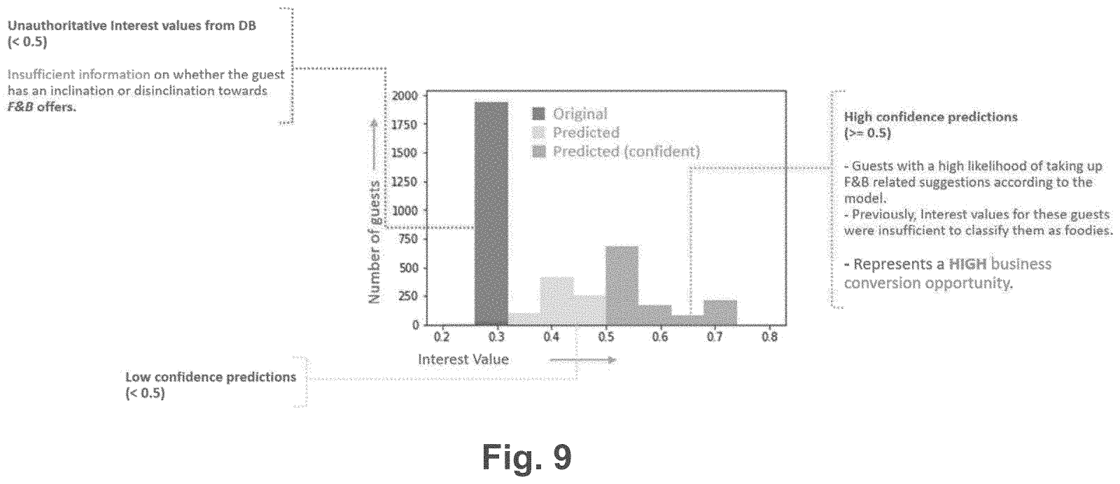

FIG. 9 illustrates example predicted business opportunities generated by embodiments of the invention. FIG. 9 is directed to the “Food and Beverage” category. As shown, for the high confidence predictions, a guest is very likely going to be receptive to a Food and Beverage related suggestion (e.g., a promotional alcoholic drink or a dessert), so that by identifying that type of guest, embodiments lead to increased revenue.

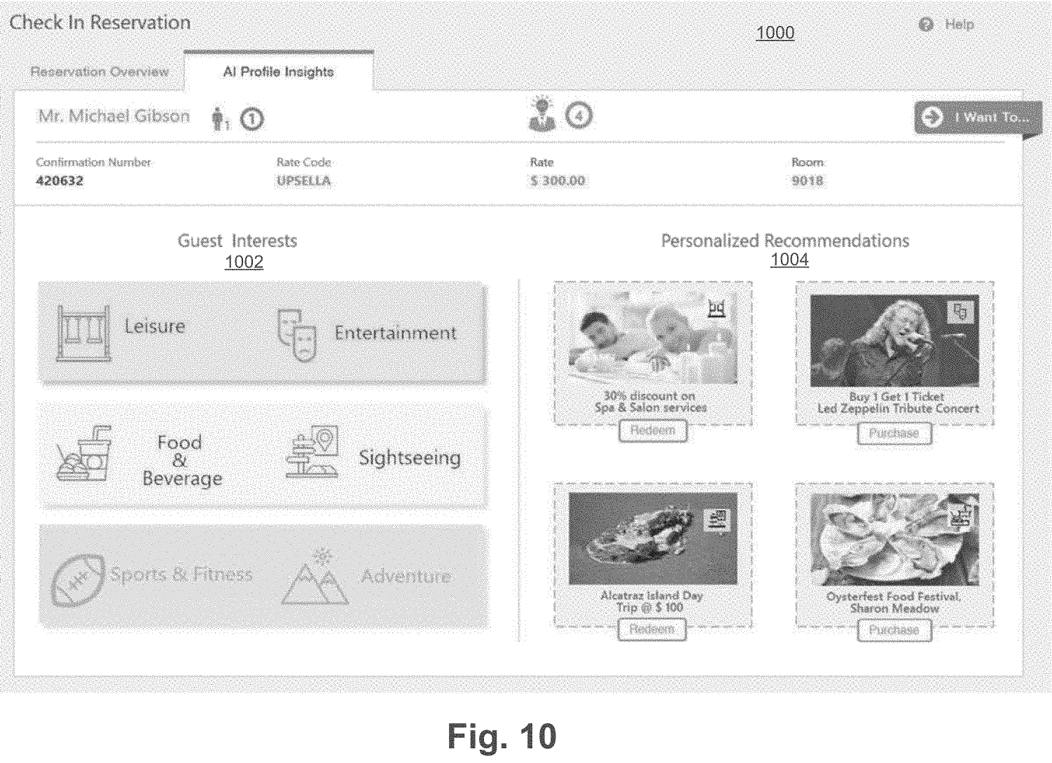

FIG. 10 illustrates an example user interface 1000 in accordance to embodiments. User interface 1000 is an example of providing recommendations at check in. At 1002, the generated categories of guest interests generated by embodiments for the particular guest is shown. At 1004, some personalized recommendations based on the guest interests are shown and would be offered to the guest upon checking in.

As disclosed, embodiments provide a purely data-driven solution that minimizes manual intervention and eliminates human bias. Embodiments are able to mine and categorize the unstructured text from the guests' stated Preferences as well as the guests' Transaction History into pre-determined Interest Categories or personas using a natural-language Semantic Analysis algorithm. Embodiments are then able to develop an understanding of the individual personas of the guests using this structured categorizations. Further, embodiments have a feedback loop that is capable of continuously improving the predictions by deriving latent feedback from the guest transaction history (i.e., spend patterns). This enables the system to constantly improve its predictions as well as incorporate concept drift.

Embodiments use collaborative filtering to make automatic predictions (filtering) about the interests of a user by collecting preferences or taste information from many users (collaborating). It is based on the idea that people who agreed in their evaluation of certain items in the past are likely to agree again in the future. Embodiments add a layer above this approach to incorporate attribute-variation, information availability, and authoritativeness of information for each guest, through Similarity Analysis calculations designed to interpret the data based on functional understanding of hotel operations. Then, the algorithm automatically maps relevant on-premise packages and offers to the guests based on their predicted interests.

While embodiments will perform better with more data, the additional layer in embodiments aims to minimize the need for comprehensive data collection on every individual guest using this Similarity algorithm. This feature enables embodiments to output predictions for first-time guests, whose personalization would otherwise go unaddressed.

In general, embodiments are applicable to both new and repeat guests. Embodiments initially determined Interest Values on all existing guests already in database 17. If a new guest arrives at the hotel, on profile creation, the entered attributes will be used to perform the similarity calculations against the existing guests in database 17. Upon completion, predictions for the new guest will be obtained.

Once the interest information is obtained, for new or repeat guests, personalized recommendations will be provided using the values obtained from the inner product of the guest-in-question's interest row of 404 of FIG. 5B with each row in 502 of FIG. 5B.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of providing recommendations to a guest of a hotel, the method comprising:
receiving input data comprising demographics data and preference data for a plurality of guests of the hotel;
receiving a plurality of guest interest categories;
assigning one or more keywords to each of the guest interest categories;
extracting a plurality of attributes from the input data concerning the guest;
performing semantic analysis to map the attributes to the guest interest categories;
determining a plurality of guest similarity calculations comprising a similarity value each of the plurality of guests with every other plurality of guests; and
generating a plurality of guest interest categories predictions for each of the guests based on the determined guest similarity calculations.

2. The method of claim 1, further comprising:
determining, from the guest similarity calculations and the guest interest categories predictions, a guest to interest matrix; and
determining a suggestion to interest matrix.

3. The method of claim 2, further comprising:
calculating an inner product of the guest to interest matrix and the suggestion to interest matrix to generate the recommendations.

4. The method of claim 3, wherein the recommendations comprise an ordered list of suggestions for the guest.

5. The method of claim 1, wherein the guest similarity calculations comprise using Collaborative Filtering with factors comprising:
a comparison of variations in attributes for each pair of guests;
an availability of information for the guest; and
an evaluation of an authoritativeness of the available information.

6. The method of claim 1, further comprising:
generating cold start values between −1 and 1 comprising guest with preferences, transaction feedback simulation and negative interest simulation.

7. The method of claim 1, further comprising generating transaction feedback and recommendation feedback.

8. The method of claim 7, further comprising increasing or decreasing interest values for the guest based on the generated feedback.

9. A computer-readable medium storing instructions which, when executed by at least one of a plurality of processors, cause the processor to provide recommendations to a guest of a hotel, the providing recommendations comprising:
receiving input data comprising demographics data and preference data for a plurality of guests of the hotel;
receiving a plurality of guest interest categories;
assigning one or more keywords to each of the guest interest categories;
extracting a plurality of attributes from the input data concerning the guest;
performing semantic analysis to map the attributes to the guest interest categories;
determining a plurality of guest similarity calculations comprising a similarity value each of the plurality of guests with every other plurality of guests; and
generating a plurality of guest interest categories predictions for each of the guests based on the determined guest similarity calculations.

10. The computer-readable medium of claim 9, the providing recommendations further comprising:
determining, from the guest similarity calculations and the guest interest categories predictions, a guest to interest matrix; and
determining a suggestion to interest matrix.

11. The computer-readable medium of claim 10, the providing recommendations further comprising:
calculating an inner product of the guest to interest matrix and the suggestion to interest matrix to generate the recommendations.

12. The computer-readable medium of claim 11, wherein the recommendations comprise an ordered list of suggestions for the guest.

13. The computer-readable medium of claim 9, wherein the guest similarity calculations comprise using Collaborative Filtering with factors comprising:
a comparison of variations in attributes for each pair of guests;
an availability of information for the guest; and
an evaluation of an authoritativeness of the available information.

14. The computer-readable medium of claim 9, the providing recommendations further comprising:
generating cold start values between −1 and 1 comprising guest with preferences, transaction feedback simulation and negative interest simulation.

15. The computer-readable medium of claim 9, the providing recommendations further comprising generating transaction feedback and recommendation feedback.

16. The computer-readable medium of claim 15, the providing recommendations further comprising increasing or decreasing interest values for the guest based on the generated feedback.

17. An artificial intelligence based recommendations system comprising:
a database storing database data comprising demographics data and preference data for a plurality of guests of a hotel;
one or more processors coupled to the database and configured to:
receive a plurality of guest interest categories;
assign one or more keywords to each of the guest interest categories;
extract a plurality of attributes from the database data concerning the guest;
perform semantic analysis to map the attributes to the guest interest categories;
determine a plurality of guest similarity calculations comprising a similarity value each of the plurality of guests with every other plurality of guests; and
generate a plurality of guest interest categories predictions for each of the guests based on the determined guest similarity calculations.

18. The system of claim 17, the processors further configured to:
determine, from the guest similarity calculations and the guest interest categories predictions, a guest to interest matrix; and
determine a suggestion to interest matrix.

19. The system of claim 18, the processors further configured to:
calculating an inner product of the guest to interest matrix and the suggestion to interest matrix to generate the recommendations.

20. The system of claim 19, wherein the recommendations comprise an ordered list of suggestions for the guest.
